(19) United States
(12) Patent Application Publication
(10) Pub. No.: US 2021/0078307 A1
(43) Pub. Date: Mar. 18, 2021

(54) Stretchable Multi-Layer Film, Method of Formation and Application, and Articles Therefrom

(71) Applicant: ENTROTECH, iNC., Columbus, OH (US)

(72) Inventor: Matthew J. CANAN, Hilliard, OH (US)

(73) Assignee: entrotech, inc., Columbus, OH (US)

(21) Appl. No.: 16/769,224

(22) PCT Filed: Sep. 19, 2019
(86) PCT No.: PCT/US2019/051988

§ 371 Date: Jun. 2, 2020

Related U.S. Application Data
(60) Provisional application No. 62/734,939, filed on Sep. 21, 2018.

(51) Int. Cl. B32B 27/08; B32B 27/40; B32B 7/12; C09J 7/38

(52) U.S. Cl. CPC B32B 27/08; B32B 27/40; B32B 7/12; C09J 7/38; B32B 2250/03; B32B 2605/00; B32B 2307/412; B32B 2307/554; B32B 2307/712; B32B 2307/584; B32B 2375/00; B32B 2250/05

(57) ABSTRACT

Multi-layer films of the invention comprise sequential layers as follows: a topcoat layer; a boundary layer; a carrier layer; and an adhesive layer. Inclusion of the boundary layer between the topcoat layer and the carrier layer was, surprisingly, found to provide a multi-layer film that is more resistant to formation therein of compromising defects during intensified stretching when applying the film to a surface. Advantageously, the boundary layer generally promotes stretchability of the multi-layer film. Articles comprising the same and methods for their formation and use are also described herein.

### BACKGROUND OF THE INVENTION

The present invention relates generally to multi-layer films useful for covering surfaces, methods of making and using the same, and articles comprising applied films of the invention.

A variety of paint protection films, paint film appliques, and other multi-layer films are known. Many of those are based on one or more polyurethane layers. Polyurethane chemistries generally provide one or more properties including the following: environmental resistance, chemical resistance, abrasion resistance, scratch resistance, optical transparency, and other often desirable properties.

Attempts have been made to combine polyurethane layers with other layers of material in the form of a multi-layer film in order to improve properties of the individual layers, such as gloss retention and environmental resistance. In some cases, an exterior (or topcoat) layer is applied to a polyurethane carrier layer in order to impart such improved properties. The inclusion of additional layers of material within a multi-layer film can negatively impact other properties, however; for example, flexibility of the multi-layer film generally decreases as more and thicker layers of material are included in multi-layer film constructions. Decreased flexibility can not only make it more difficult to adequately conform the multi-layer film for adequate adherence to contoured surfaces, but it can also lead to premature edge lift of the multi-layer film during use. In addition, inadequate compatibility between adjacent layers can lead to potential interlayer delamination within such multi-layer films.

Several multi-layer films are readily available on the market today for use in paint protection. For example, Minnesota Mining & Manufacturing Co. (“3M”) in St. Paul, Minn., markets polyurethane-based sheet “Paint Protection Film” under the SCOTCHGARD and VENTURESHIELD product lines. PCT Patent Publication No. WO 02/28636 describes a finishing film comprising a flexible polymeric sheet material having a first major surface and a second major surface and a pressure sensitive adhesive layer covering at least a portion of the first major surface of the sheet material. The finishing film is described as being commercially available from 3M Co. under the trade designation, SCOTCHCAL PAINT PROTECTION FILM PUL 0612, and comprising a 6-mil polymer film comprising an aliphatic polycaprolactone-based thermoplastic urethane elastomer. Examples of methods for formation of the polymer film described therein are extrusion, calendaring, wet casting, and the like. Thereafter, a waterborne polyurethane coating is formed on one side of the polymer film, with the other side of the polymer film being laminated to an acrylic pressure sensitive adhesive.

PCT Patent Publication No. WO 03/002680 describes an adhesive sheet comprising a flexible base material, an adhesive layer disposed on a back surface of said base material, and a protective layer disposed on a front surface of the base material. The protective layer described in PCT Patent Publication No. WO 03/002680 is made of a hydrophilic film containing a curing resin and a hydrophilic agent of an inorganic oxide. The base material contains a layer of a first polyurethane resin that is a reaction product of polyester polyol and a polyfunctional isocyanate compound. Preferably, the base material comprises a lower layer containing the first polyurethane resin and an upper layer disposed between the lower layer and the protective layer that adheres to the protective layer and contains a second polyurethane resin that is a reaction product of a polycarbonate polyol and a polyfunctional isocyanate compound. The upper layer preferably comprises a hard polyurethane resin in comparison with the first polyurethane resin of the lower layer to enable adhesion between the entire base material and the protective layer to be effectively increased through the upper layer, even if the film of the protective layer is comparatively hard and has a low-temperature elongation, differing to a large extent from that of the lower layer of the base material. The polyester polyol forming the first polyurethane resin may be formed from a diol having caprolactonediol in the main chain.

U.S. Pat. No. 8,765,263 describes a multilayer protective film comprising a first layer, a second layer, and a pressure sensitive adhesive (PSA) layer. The first layer at least comprises a polyester-based polyurethane, a polycarbonate-based polyurethane, or a combination or blend of both. The second layer at least comprises a polycaprolactone-based thermoplastic polyurethane. One major surface of the first layer is bonded to one major surface of the second layer, and the PSA layer is bonded to an opposite major surface of the second layer such that the second layer is sandwiched between the first layer and the PSA layer. The predominant method of forming the second layer is described as extruding the polycaprolactone-based thermoplastic polyurethane at an elevated temperature through a die, although casting and injection molding are also described.

Typical during installation of such films is the need to stretch the film to adequately conform to non-planar substrates. When installed on hoods of automobiles, for example, film is often stretched about 10% to a stretched length of about 110%. To assist in stretchability of such films, the film is often heated. In practice, however, amount of stretch is often inconsistent throughout a film. For example, when the film is tacked (e.g., adhered to a substrate) too close to the portion of the film being stretched over adjacent portions of the substrate, stretch is often intensified in that portion of film. As another example, when the film is not heated uniformly over the area where it is stretched, stretch is often intensified in those portions of the film being stretched at a lower temperature. As a result, some portions of the film are subjected to stretch of at least about 20% or more, while stretch in other areas is much less. Problematic, however, is the fact that localized stretch to amounts as high as about 50% is not uncommon.

When film is stretched during the installation process, particularly to such a large degree in localized areas, properties of the films are often compromised. Defects such as cracks, which extend longitudinally through a portion of the film's thickness, and, to a greater degree, splits, which extend longitudinally through the film's entire thickness, are often present in such films as evidence of their compromised properties. Given that installers of such film cannot always be relied upon to following installation instructions and take precautions in minimizing intensified stretch across all portions of the film being installed, film with properties more resistant to being compromised during intensified stretching are desirable.

### SUMMARY OF THE INVENTION

Multi-layer films of the invention comprise sequential layers as follows: a topcoat layer; a boundary layer; a carrier layer; and an adhesive layer. Inclusion of the boundary layer was, surprisingly, found to provide a multi-layer film that is more resistant to formation therein of compromising defects during intensified stretching when applying the film to a surface. Advantageously, the boundary layer generally promotes stretchability of the multi-layer film. Articles comprising the same and methods for their formation and use are also described herein.

### BRIEF DESCRIPTION OF THE SEVERAL VIEWS OF THE DRAWINGS

FIG. 1A is a black-and-white photograph of a SEM image of the multi-layer film of Example 1 after being stretched 30%.

FIG. 1B is a black-and-white photograph of a SEM image of the multi-layer film of Example 1 after being stretched 60%.

FIG. 2A, which is prior art, is a black-and-white photograph of a SEM image of the multi-layer film of Comparative Example C1 after being stretched 30%.

FIG. 2B, which is prior art, is a black-and-white photograph of a SEM image of the multi-layer film of Comparative Example C1 after being stretched 60%.

FIG. 3A, which is prior art, is a black-and-white photograph of a SEM image of the multi-layer film of Comparative Example C2 after being stretched 30%.

FIG. 3B, which is prior art, is a black-and-white photograph of a SEM image of the multi-layer film of Comparative Example C2 after being stretched 60%.

FIG. 4A, which is prior art, is a black-and-white photograph of a SEM image of the multi-layer film of Comparative Example C3 after being stretched 30%.

FIG. 4B, which is prior art, is a black-and-white photograph of a SEM image of the multi-layer film of Comparative Example C3 after being stretched 60%.

### DETAILED DESCRIPTION OF THE INVENTION

Multi-layer films of the invention comprise at least a carrier layer interposed between an outwardly exposed topcoat layer and an outwardly exposed adhesive layer. Further, the multi-layer film also comprises an internal boundary layer. Preferably, the boundary layer is immediately adjacent to and interposed between the outwardly exposed topcoat layer and the internal carrier layer.

The boundary layer and the internal carrier layer are distinguishable based on their relative moduli and thicknesses. Relative moduli according to the invention refers to relative values of the secant modulus of the layer of material. Secant modulus is understood to be the value of stress divided by strain at a given value of stress or strain and is often referred to as the stress-strain ratio. For purposes of this invention when determining relative moduli, the secant modulus is evaluated for the layer at an elongation of 10% (also referred to as the M10 modulus). A DMA Q800 available from TA Instruments (New Castle, Del.) can be used to determine the relative moduli, evaluating samples each having a size of 4-8 millimeters wide, 0.02-0.04 millimeter thick, and 5-12 millimeters long at a stress ramp rate of 18 MPa per minute to failure (or machine limits). Moduli can also be determined by testing according to ISO 527-2 or ASTM D-412 test methods. The M10 modulus for a layer is calculated by dividing the stress at 10% elongation by 0.1 (strain=10%).

In general, the M10 modulus of boundary layers of the invention is greater than the M10 modulus of the internal carrier layer. In one embodiment, the M10 modulus of the boundary layer is at least about 20% greater than the M10 modulus of the carrier layer. In a further embodiment, the M10 modulus of the boundary layer is at least about 50% greater than the M10 modulus of the carrier layer. In yet a further embodiment, the M10 modulus of the boundary layer is at least about 75% greater than the M10 modulus of the carrier layer. In yet a further embodiment still, the M10 modulus of the boundary layer is at least about 100% greater than the M10 modulus of the carrier layer.

In another embodiment, the M10 modulus of the boundary layer is at least about 20% greater than the M10 modulus of the carrier layer and at least about 20% greater than the M10 modulus of the topcoat layer sandwiching the boundary layer. In a further embodiment, the M10 modulus of the boundary layer is at least about 50% greater than the M10 modulus of the carrier layer and the M10 modulus of the topcoat layer. In yet a further embodiment, the M10 modulus of the boundary layer is at least about 75% greater than the M10 modulus of the carrier layer and the M10 modulus of the topcoat layer. In yet a further embodiment still, the M10 modulus of the boundary layer is at least about 100% greater than the M10 modulus of the carrier layer and the M10 modulus of the topcoat layer.

The boundary layer generally promotes stretchability of the multi-layer film. In one embodiment, the boundary layer has an ultimate elongation that is greater than that of the topcoat layer. In a further embodiment, ultimate elongation of the boundary layer is at least about 25% greater than ultimate elongation of the topcoat layer. In yet a further embodiment, ultimate elongation of the boundary layer is at least about 50% greater than ultimate elongation of the topcoat layer. In still yet a further embodiment, ultimate elongation of the boundary layer is at least about 100% greater than ultimate elongation of the topcoat layer.

To offset the increased overall stiffness arising from inclusion of the relatively high modulus boundary layer—as compared to modulus of the carrier layer—in the multi-layer film, it has been found beneficial to use a lower modulus carrier layer than is typically used in many multi-layer films consisting of a topcoat layer, carrier layer, and adhesive layer, for example. In one embodiment, the M10 modulus of the carrier layer is less than about 20 MPa at 25° C. In another embodiment, the M10 modulus of the carrier layer is less than about 15 MPa at 25° C.

The secant modulus can also be evaluated for a layer at an elongation of 100% (also referred to as the M100 modulus), whereby the M100 modulus for the layer is then equal to the stress at 100% elongation. In one embodiment, the M100 modulus of the carrier layer is less than about 5 MPa at 25° C. In another embodiment, the M100 modulus of the carrier layer is less than about 4 MPa at 25° C.

In one embodiment, modulus of the boundary layer decreases at a slower rate as temperature is increased as compared to behavior exhibited by the carrier layer when similarly tested. In another embodiment, modulus of the boundary layer decreases at a slower rate as temperature is increased as compared to behavior exhibited by the topcoat layer when similarly tested. In a further embodiment, modulus of the boundary layer decreases at a slower rate as temperature is increased as compared to behavior exhibited by both the carrier layer and the topcoat layer when similarly tested. For example, M100 modulus of the boundary layer at 60° C. is at least about 60% of the M100 modulus of that boundary layer at 25° C. in one embodiment. In another embodiment, M100 modulus of the boundary layer at 60° C. is at least about 70% of the M100 modulus of that boundary layer at 25° C. To determine moduli values for purposes of this analysis, a DMA Q800 available from TA Instruments (New Castle, Del.) can be used to determine the moduli, evaluating samples each having a size of 4-8 millimeters wide, 0.02-0.04 millimeter thick, and 5-12 millimeters long in tension mode at a frequency of 1 Hz, a strain of 0.3%, and a temperature ramp rate of 3° C./minute to failure (or machine limits). Moduli can also be determined by testing according to ISO 527-2 or ASTM D-412 test methods.

As compared to the internal carrier layer, the boundary layer has a thickness that is less than about 50% of thickness of the carrier layer. In a preferred embodiment, the boundary layer's thickness is less than about 20% of thickness of the carrier layer.

Unexpectedly, use of such a boundary layer within (and interior to) a multi-layer film facilitates obtainment of superior stretchability of the multi-layer film without compromised integrity. Compromised integrity is evidenced by, for example, cracking, splitting, and the like of the multi-layer film upon stretching. While the carrier layer in this further embodiment can be extruded or in-situ polymerized, as described in more detail below, preferably it is in-situ polymerized.

Carrier Layer

The term “carrier layer” is used herein to refer to the layer(s) interposed between the outwardly exposed topcoat layer and the outwardly exposed adhesive layer. In certain contexts, a carrier layer may also be referred to as a “base layer” or a similar designation. In general, the carrier layer of multi-layer films of the invention is referred to as a “mid-ply layer” when it contains multiple layers (i.e., “n” number of individual layers). However, the carrier layer of multi-layer films of the invention can be a single film layer according to other embodiments of the invention. When multiple layers form the carrier layer, each of the “n” individual layers can be the same or different chemistries. In an exemplary embodiment, each of the “n” individual layers has essentially the same chemistry.

In an exemplary embodiment, carrier layers used in multi-layer films of the invention are polyurethane-based. For simplicity, the term “polyurethane” as used herein includes polymers containing urethane (also known as carbamate) linkages, urea linkages, or combinations thereof (i.e., in the case of poly(urethane-urea)s). Thus, polyurethane-based carrier layers contain at least urethane linkages, urea linkages, or combinations thereof. Furthermore, polyurethane-based carrier layers are based on polymers where the polymeric backbone has at least 80% urethane and/or urea repeat linkages formed during the polymerization process.

Polyurethane-based carrier layers are prepared according to methods of the invention by reacting components, which include at least one isocyanate-reactive (e.g., hydroxy-functional, such as polyol) component and at least one isocyanate-functional (e.g., polyisocyanate) component. For example, components of exemplary polymerizable compositions and which are useful in the formation of preferred polyurethane-based carrier layers according to methods of the invention are described in U.S. Patent Publication No. US-2011-0241261-A1, entitled “Methods for Polymerizing Films In-Situ Using a Radiation Source” and incorporated herein by reference in its entirety. Such in-situ polymerized carrier layers, which, as described in PCT Patent Application No. WO 2017/156507, provide improvements to conventional protective sheets, are preferably used as the carrier layer in multi-layer films of the present invention.

In exemplary embodiments, polymerization of the polymerizable composition is initiated using at least one radiation source selected from ultraviolet radiation, thermal radiation, and electron beam radiation. Methods of the invention can utilize continuous processing or batch processing. For example, continuous processing, such as web-based polymerization of the polyurethane-based carrier layer using relatively low energy ultraviolet radiation, can be used in one embodiment of the invention. As another example, batch processing, such as coating an ultraviolet-curable composition on a discrete substrate and irradiating the same to form the polyurethane-based carrier layer can be used in another embodiment of the invention.

According to a preferred aspect of methods of the invention, the polymerizable composition for formation of the polyurethane-based carrier layer is essentially free of solvents. In addition to, for example, environmental and safety concerns associated with solvent-based processing, solvent-based processing typically entails use of elevated temperatures for effective removal of excess solvent from the polymerized composition. It is preferred that polyurethane-based carrier layers are essentially free of unreacted solvent. Thus, it is preferred that the polymerizable compositions from which they are formed are essentially free of solvents.

Given its recognized beneficial properties, the carrier layer comprises a polycaprolactone-based polyurethane according to an exemplary embodiment of the invention. Any suitable polycaprolactone-based polyurethane can be used for the carrier layer, which is not limited to those that are in-situ polymerized. For example, Schweitzer-Mauduit International, Inc. (Greenfield, Mass.) supplies other polycaprolactone-based polyurethane films under the ArgoGuard™ 46510, ArgoGuard™ 49510, and ArgoGuard™ 49510-60DV trade designations.

Any suitable additives can be present in the carrier layer. Other additives are selected as known to those skilled in the art based on the intended application. Those skilled in the art are readily able to determine the amount of such additives to use for the desired effect.

According to one embodiment of the invention, the carrier layer has a thickness of about 5 microns to about 1,250 microns. Each of the “n” number of individual film layers therein can be as thin as about 5 microns and up to about 50 microns in thickness, the presence of thicker layers being particularly useful for ballistic applications. However, to impart greater stretchability, a carrier layer having a thickness of about 220 microns or less is used according to one aspect of the invention. According to further aspects, the carrier layer has a thickness of about 180 microns or less. For example, the carrier layer can have a thickness of about 120 microns to about 180 microns. Not only is stretchability of the carrier layer, and hence overall multi-layer film, enhanced by using a thinner carrier layer, overall cost is reduced in this manner.

Topcoat Layer

In general, any outwardly exposed non-adhesive layer on a major planar side of the multi-layer film opposite the adhesive layer is referred to as the “topcoat layer.” Consistent with its name, the topcoat layer is an outwardly exposed, exterior layer of the multi-layer film as applied to an article. Any suitable type of material can be used for the topcoat layer in multi-layer films of the invention.

The topcoat layer can comprise any suitable chemistry. In general, the topcoat layer provides one or more properties including the following: environmental resistance, chemical resistance, abrasion resistance, scratch resistance, optical transparency, and other often desirable properties. According to an exemplary embodiment, the topcoat layer is non-yellowing and exhibits gloss retention (e.g., maintaining of gloss on the order of about 80 to about 90 gloss units). In an exemplary embodiment, the topcoat layer comprises a polyurethane-based material. Many suitable topcoats are commercially available, including for example, polyurethane coatings sold by PPG Aerospace PRC-DeSoto of Sylmar, Calif. under the Desothane™ HS trade designation (e.g., Desothane™ HS CA8000).

In one embodiment, when present, the topcoat layer has a thickness of about 1 microns to about 28 microns. In a further embodiment, the topcoat layer has a thickness of about 5 microns to about 20 microns. In still a further embodiment, the topcoat layer has a thickness of about 5 microns to about 15 microns. In yet a further embodiment, the topcoat layer has a thickness of about 5 microns to about 12 microns. In yet a further embodiment, the topcoat layer has a thickness of about 5 microns to about 7 microns. However, the thickness of the topcoat layer can vary substantially without departing from the spirit and scope of the invention.

To protect the topcoat layer until application of the multi-layer film to a substrate, a polymer liner (e.g., a clear polyester liner) or the like may be positioned adjacent the topcoat layer such that the liner, as opposed to the topcoat layer, is temporarily outwardly exposed. After application of the multi-layer film to a substrate, such an optional liner is generally removed for effective operation of the multi-layer film.

Boundary Layer

Interposed between the topcoat layer and the carrier layer is a boundary layer according to the invention. Inclusion of the boundary layer was, surprisingly, found to provide a multi-layer film that is more resistant to formation therein of compromising defects during intensified stretching when applying the film to a surface. As discussed in the background herein, cracks and splits in the film often arise as evidence of the film's compromised integrity after application to a surface. The propensity for such defects to arise in multi-layer films is increased when utilizing a topcoat layer formulated to provide properties desired for many applications, which properties include the following: environmental resistance, chemical resistance, abrasion resistance, scratch resistance, and optical transparency.

The boundary layer is polymeric and can comprise as its base polymer a polycarbonate, a polyvinyl fluoride, a poly(meth)acrylate (e.g., a polyacrylate or a polymethacrylate), a polyurethane, modified (e.g., hybrid) polymers thereof, or combinations thereof. In a preferred embodiment, the boundary layer is polyurethane-based. See U.S. Pat. No. 4,476,293 for a description of exemplary polycarbonate-based polyurethanes useful for the boundary layer of the invention. Any suitable additives can be present in conjunction with the base polymer in the boundary layer. Other additives are selected as known to those skilled in the art based on details of an intended application.

The boundary layer is of relatively high molecular weight, as evidenced by its melting point. That is, while the boundary layer can be formed by extrusion according to some embodiments of the invention, the boundary layer is preferably of a sufficient molecular weight that extrusion thereof is not practical (i.e., if a polyurethane, the polyurethane is not considered extrusion-grade polyurethane by those of ordinary skill in the art).

The boundary layer has any suitable thickness so as not to prevent obtainment of desired properties associated with its stretchability. In one embodiment, the boundary layer has a thickness of about 1 micron to about 125 microns, or more specifically about 3 microns to about 95 microns. In an exemplary embodiment, the boundary layer has a thickness of about 20 microns or less, more specifically about 5 microns to about 15 microns.

According to one aspect of the invention, a boundary layer of the desired thickness is formed using solution or dispersion chemistry. Solution and dispersion chemistries are well known to those skilled in the art. While the percentage solids will vary, in one embodiment, a solution or dispersion having about 10-15% solids was found to be useful for formation of the boundary layer.

In one embodiment, a polyurethane film suitable for the boundary layer can be prepared and formed into a film using solution or dispersion chemistry and film coating techniques known to those skilled in the art. Such a film can be prepared by reacting components, including at least one isocyanate-reactive component, at least one isocyanate-functional component, and, optionally, at least one reactive emulsifying compound, to form an isocyanate-terminated polyurethane prepolymer. The polyurethane prepolymer can then be dispersed, and optionally chain-extended, in a dispersing medium to form a polyurethane-based dispersion that can be cast to form a polyurethane film. This method is preferred for preparation of boundary layers according to the invention.

When the polyurethane film is prepared from an organic solventborne or waterborne system, once the solution or dispersion is formed, it is easily applied to a substrate and then dried to form a polyurethane film. As known to those of ordinary skill in the art, drying can be carried out either at room temperature (i.e., about 20° C.) or at elevated temperatures (e.g., about 25° C. to about 150° C.). For example, drying can optionally include using forced air or a vacuum. This includes the drying of static-coated substrates in ovens, such as forced air and vacuum ovens, or drying of coated substrates that are continuously conveyed through chambers heated by forced air, high-intensity lamps, and the like. Drying may also be performed at reduced (i.e., less than ambient) pressure.

Any suitable isocyanate-reactive component can be used. The isocyanate-reactive component contains at least one isocyanate-reactive material or mixtures thereof. As understood by one of ordinary skill in the art, an isocyanate-reactive material includes at least one active hydrogen. Those of ordinary skill in the polyurethane chemistry art will understand that a wide variety of materials are suitable for this component. For example, amines, thiols, and polyols are isocyanate-reactive materials.

However, it is preferred that the isocyanate-reactive material be a hydroxy-functional material. Polyols are the preferred hydroxy-functional material used in the present invention. Polyols provide urethane linkages when reacted with an isocyanate-functional component, such as a polyisocyanate.

Polyols, as opposed to monols, have at least two hydroxy-functional groups. Diols contribute to formation of relatively high molecular weight polymers without requiring crosslinking, such as is conventionally introduced by polyols having greater than two hydroxy-functional groups. Examples of polyols useful in the present invention include, but are not limited to, polyester polyols (e.g., lactone polyols) and the alkylene oxide (e.g., ethylene oxide; 1,2-epoxypropane; 1,2-epoxybutane; 2,3-epoxybutane; isobutylene oxide; and epichlorohydrin) adducts thereof, polyether polyols (e.g., polyoxyalkylene polyols, such as polypropylene oxide polyols, polyethylene oxide polyols, polypropylene oxide polyethylene oxide copolymer polyols, and polyoxytetramethylene polyols; polyoxycycloalkylene polyols; polythioethers; and alkylene oxide adducts thereof), polyalkylene polyols, polycarbonate polyols, mixtures thereof, and copolymers therefrom.

Polycarbonate-based polyurethanes are preferred according to one embodiment. It was found that this type of polyurethane chemistry easily facilitated obtainment of polyurethane-based films with properties desired. Accordingly, in one preferred embodiment, a polycarbonate diol is used to prepare polycarbonate-based polyurethane according to the invention. Although polyols containing more than two hydroxy-functional groups are generally less preferred than diols, certain higher functional polyols may also be used in the present invention. These higher functional polyols may be used alone, or in combination with other isocyanate-reactive materials, for the isocyanate-reactive component.

For broader formulation latitude, at least two isocyanate-reactive materials, such as polyols, may be used for the isocyanate-reactive component. However, as any suitable isocyanate-reactive component can be used to form the polyurethane, much latitude is provided in the overall polyurethane chemistry.

The isocyanate-reactive component is reacted with an isocyanate-functional component during formation of the polyurethane. The isocyanate-functional component may contain one isocyanate-functional material or mixtures thereof. Polyisocyanates, including derivatives thereof (e.g., ureas, biurets, allophanates, dimers and trimers of polyisocyanates, and mixtures thereof), (hereinafter collectively referred to as “polyisocyanates”) are the preferred isocyanate-functional materials for the isocyanate-functional component. Polyisocyanates have at least two isocyanate-functional groups and provide urethane linkages when reacted with the preferred hydroxy-functional isocyanate-reactive components. In one embodiment, polyisocyanates useful for preparing polyurethanes are one or a combination of any of the aliphatic or aromatic polyisocyanates commonly used to prepare polyurethanes.

Generally, diisocyanates are the preferred polyisocyanates. Useful diisocyanates include, but are not limited to, aromatic diisocyanates, aromatic-aliphatic diisocyanates, aliphatic diisocyanates, cycloaliphatic diisocyanates, and other compounds terminated by two isocyanate-functional groups (e.g., the diurethane of toluene-2,4-diisocyanate-terminated polypropylene oxide polyol).

Examples of preferred diisocyanates include the following: 2,6-toluene diisocyanate; 2,5-toluene diisocyanate; 2,4-toluene diisocyanate; phenylene diisocyanate; 5-chloro-2,4-toluene diisocyanate; 1-chloromethyl-2,4-diisocyanato benzene; xylylene diisocyanate; tetramethyl-xylylene diisocyanate; 1,4-diisocyanatobutane; 1,6-diisocyanatohexane; 1,12-diisocyanatododecane; 2-methyl-1,5-diisocyanatopentane; methylenedicyclohexylene-4,4′-diisocyanate; 3-isocyanatomethyl-3,5,5′-trimethylcyclohexyl isocyanate (isophorone diisocyanate); 2,2,4-trimethylhexyl diisocyanate; cyclohexylene-1,4-diisocyanate; hexamethylene-1,6-diisocyanate; tetramethylene-1,4-diisocyanate; cyclohexane-1,4-diisocyanate; naphthalene-1,5-diisocyanate; diphenylmethane-4,4′-diisocyanate; hexahydro xylylene diisocyanate; 1,4-benzene diisocyanate; 3,3′-dimethoxy-4,4′-diphenyl diisocyanate; phenylene diisocyanate; isophorone diisocyanate; polymethylene polyphenyl isocyanate; 4,4′-biphenylene diisocyanate; 4-isocyanatocyclohexyl-4′-isocyanatophenyl methane; and p-isocyanatomethyl phenyl isocyanate.

When preparing polyurethane dispersions for casting into layers of polyurethane, the isocyanate-reactive and isocyanate-functional components may optionally be reacted with at least one reactive emulsifying compound according to one embodiment of the invention. The reactive emulsifying compound contains at least one anionic-functional group, cationic-functional group, group that is capable of forming an anionic-functional group or cationic-functional group, or mixtures thereof. This compound acts as an internal emulsifier because it contains at least one ionizable group. Thus, these compounds are referred to as “reactive emulsifying compounds.”

Reactive emulsifying compounds are capable of reacting with at least one of the isocyanate-reactive and isocyanate-functional components to become incorporated into the polyurethane. Thus, the reactive emulsifying compound contains at least one, preferably at least two, isocyanate- or active hydrogen-reactive- (e.g., hydroxy-reactive) groups. Isocyanate- and hydroxy-reactive groups include, for example, isocyanate, hydroxyl, mercapto, and amine groups.

Preferably, the reactive emulsifying compound contains at least one anionic-functional group or group that is capable of forming such a group (i.e., an anion-forming group) when reacted with the isocyanate-reactive (e.g., polyol) and isocyanate-functional (e.g., polyisocyanate) components. The anionic-functional or anion-forming groups of the reactive emulsifying compound can be any suitable groups that contribute to ionization of the reactive emulsifying compound. For example, suitable groups include carboxylate, sulfate, sulfonate, phosphate, and similar groups. As an example, dimethylolpropionic acid (DMPA) is a useful reactive emulsifying compound. Furthermore, 2,2-dimethylolbutyric acid, dihydroxymaleic acid, and sulfopolyester diol are other useful reactive emulsifying compounds. Those of ordinary skill in the art will recognize that a wide variety of reactive emulsifying compounds are useful in preparing polyurethanes for the present invention.

One or more chain extenders can also be used in preparing polyurethanes of the invention. For example, such chain extenders can be any or a combination of the aliphatic polyols, aliphatic polyamines, or aromatic polyamines conventionally used to prepare polyurethanes.

Illustrative of aliphatic polyols useful as chain extenders include the following: 1,4-butanediol; ethylene glycol; 1,6-hexanediol; glycerine; trimethylolpropane; pentaerythritol; 1,4-cyclohexane dimethanol; and phenyl diethanolamine. Also note that diols such as hydroquinone bis(β-hydroxyethyl)ether; tetrachlorohydroquinone-1,4-bis(β-hydroxyethyl)ether; and tetrachlorohydroquinone-1,4-bis(β-hydroxyethyl)sulfide, even though they contain aromatic rings, are considered to be aliphatic polyols for purposes of the invention. Aliphatic diols of 2-10 carbon atoms are preferred. Especially preferred is 1,4-butanediol.

Illustrative of useful polyamines are one or a combination of the following: p,p′-methylene dianiline and complexes thereof with alkali metal chlorides, bromides, iodides, nitrites and nitrates; 4,4′-methylene bis(2-chloroaniline); dichlorobenzidine; piperazine; 2-methylpiperazine; oxydianiline; hydrazine; ethylenediamine; hexamethylenediamine; xylylenediamine; bis(p-aminocyclohexyl)methane; dimethyl ester of 4,4′-methylenedianthranilic acid; p-phenylenediamine; m-phenylenediamine; 4,4′-methylene bis(2-methoxyaniline); 4,4′-methylene bis(N-methylaniline); 2,4-toluenediamine; 2,6-toluenediamine; benzidine; 3,4′-dimethylbenzidine; 3,3′-dimethoxybenzidine; dianisidine; 1,3-propanediol bis(p-aminobenzoate); isophorone diamine; 1,2-bis(2′-aminophenylthio)ethane; 3,5-diethyl toluene-2,4-diamine; and 3,5-diethyl toluene-2,6-diamine. The amines preferred for use are 4,4′-methylene bis(2-chloroaniline); 1,3-propanediol bis(p-aminobenzoate); and p,p′-methylenedianiline and complexes thereof with alkali metal chlorides, bromides, iodides, nitrites and nitrates.

No matter the chemistry, the boundary layer is preferably essentially uncrosslinked. While the use of certain amounts of crosslinker may still allow formation of a suitable boundary layer, if crosslinkers are present, they are generally used in an amount of less than about 4 parts by weight, and preferably less than about 2 parts by weight, based on 100 parts by weight of any polymer crosslinkable therewith prior to any crosslinking reaction. Further, crosslinkers may be present if they are not used in combination with polymers that are crosslinkable therewith or where, if crosslinkable, resulting crosslink density is minimal (e.g., due to minimal reactive sites on the base polymer) so as not to significantly affect stretchability of the overall multi-layer film. In a preferred embodiment, the boundary layer is essentially free of crosslinkers and reaction products thereof. As such, crosslinkers and reaction products are not discernible when using chemical analysis.

In an exemplary preferred embodiment, a polyurethane-based topcoat layer described in U.S. Patent Publication No. US-2008-0286576, incorporated herein by reference in its entirety, is used as the boundary layer. Such a layer is described in U.S. Patent Publication No. US-2008-0286576 as an exterior (or topcoat) layer applied to a carrier layer in order to impart improved gloss retention. Unexpectedly, use of such a material instead as a boundary layer within (and interior to) a multi-layer film facilitates obtainment of superior stretchability of the multi-layer film without compromised integrity and while allowing broader formulation latitude in the topcoat layer to obtain properties desired therein. Compromised integrity is evidenced by, for example, cracking, splitting, and the like of the multi-layer film upon stretching.

Adhesive Layer

The adhesive layer is outwardly exposed on a major planar side of the multi-layer film opposite from that on which the topcoat layer is present. Any suitable adhesive can be used for the adhesive layer according to the invention. In a preferred embodiment, the adhesive layer comprises a pressure-sensitive adhesive.

While any suitable chemistry can be used for the base polymer in the adhesive layer, (meth)acrylate—acrylate and methacrylate—chemistry is preferred. However, other suitable chemistries are known to those skilled in the art and include, for example, those based on synthetic and natural rubbers, polybutadiene and copolymers thereof, polyisoprene or copolymers thereof, and silicones (e.g., polydimethylsiloxane and polymethylphenylsiloxane). Any suitable additives can be present in conjunction with the base polymer in the adhesive layer.

In particular, an adhesive based on 2-ethyl hexyl acrylate, vinyl acetate, and acrylic acid monomers polymerized as known to those skilled in the art was found useful in one embodiment of the invention. The adhesive can be crosslinked, for example, using conventional aluminum or melamine crosslinkers.

In one embodiment, the adhesive layer has a thickness of about 5 microns to about 150 microns. In a further embodiment, the adhesive layer has a thickness of about 30 microns to about 100 microns. However, the thickness of the adhesive layer can vary substantially without departing from the spirit and scope of the invention.

Similar to temporary use of a liner on the topcoat layer, until its application on a surface, the adhesive layer can be protected using, for example, a conventional release liner. As such, the multi-layer film can be stored and shipped easily in roll or other forms until its application.

Formation of Multi-Layer Film

In one embodiment, each of the individual layers of the multi-layer film is prepared before assembly into the final multi-layer film. Any suitable method for preparation of each can be used as known to those skilled in the art.

For preparation of the carrier layer, for example, a film can be extruded onto a separate carrier film (e.g., polyester film) to form a supported carrier layer, after which the boundary layer is formed thereon. The supporting carrier film is removed at some point before the adhesive layer is applied to the side of the carrier layer opposite the boundary layer.

For preparation of the adhesive layer, any suitable method can be used. For example, a film of the desired thickness can be cast onto a release film according to one embodiment and as known to those skilled in the art. In one embodiment, the film of adhesive contained on the release film can be laminated to the carrier layer after the supporting carrier film is removed from the carrier layer.

For preparation of the topcoat layer, any suitable method can be used. For example, a topcoat film of the desired thickness can be cast onto a smooth film (e.g., polyester) according to one embodiment and as known to those skilled in the art. In one embodiment, the supported topcoat film is then laminated to the boundary layer. The smooth film used for formation of the topcoat film can remain in the assembly until application of the sheet to a surface in order to provide extra protection during shipping and storage of the multi-layer film. According to this embodiment, any suitable method can be used to laminate the topcoat layer to the boundary layer. According to another embodiment, the topcoat layer is formed by direct coating onto the boundary layer according to conventional methods.

While the above-described process relies primarily on preparation of individual layers and then adherence of those layers together to form the multi-layer film, according to another embodiment of the invention, some of the layers can be formed simultaneously by co-extrusion. Individual layers may be in-situ polymerized into a film format as described in, for example, U.S. Pat. No. 8,828,303, U.S. Patent Publication No. US-2011-0137006-A1, and PCT Patent Application No. WO 2017/156507. No matter what method is used, the process can be a continuous or batch process.

Use of Multi-Layer Film

Multi-layer films of the invention are useful in a range of indoor and outdoor applications in, for example, the transportation, architectural and sporting goods industries. The multi-layer films can advantageously be applied to at least a portion of a surface of any article where protection or decoration (e.g., with paint) is desired. Such articles include, for example, motorized vehicles and non-motorized vehicles (e.g., conventional bicycles) amongst a multitude of other applications. Surfaces on which the multi-layer films are applicable can be, for example, painted or unpainted. When the multi-layer film is pigmented or otherwise, it can be used itself as paint in film form (also referred to as a paint film applique). When the multi-layer film is adhered to a surface primarily for the purpose of protecting paint existing on the underlying surface, it is often referred to as a paint protection film.

Multi-layer films of the invention can be readily and easily applied to a surface based on knowledge of those skilled in the art. The adhesive layer is generally adhered to the surface to be protected after removal of any release liner present thereon to expose the adhesive. When a pressure-sensitive adhesive layer is used, the multi-layer film can be more easily repositioned before being firmly adhered to a surface. After application of the multi-layer film to a surface, if used, the temporary liner adjacent the topcoat layer is removed to outwardly expose the topcoat layer during use.

Exemplary embodiments and applications of the invention are described in the following non-limiting examples.

Scanning Electron Micrography (SEM) Test Method

In order to evaluate properties associated with stretchability for each of the exemplified multi-layer films, samples were prepared, stretched, and analyzed in high vacuum using SEM to determine the presence of any cracks, splitting, or the like. Specifications for the SEM images obtained using a FEI Quanta™ 200 SEM (Thermo Fisher Scientific of Hillsboro, Oreg.) were as follows: HV 30.0 kV, Spot 3.0, WD 11.8 mm, Magnification 100×, and Det. SSD.

Four film samples of each exemplified multi-layer film were applied to a stainless steel test panel in an elongated state after being stretched to the desired elongation percentage (all performed at room temperature). One of the film samples was longitudinally hand-stretched by 30%, another of the film samples was longitudinally hand-stretched by 40%, another of the film samples was longitudinally hand-stretched by 50%, and the other film sample was longitudinally hand-stretched by 60%. It is to be understood that a film sample hand-stretched by 30% is elongated to 130% of its initial length. The same principle applies with respect to indicated stretch percentages.

Approximately one hour after application of each film sample to the test panel, the assembly was exposed to an elevated temperature of about 90° C. by placing the assembly into a box oven for either two or twenty-four hours, as indicated below. After removal from the oven and cooling to room temperature, the samples were analyzed using SEM.

Alternative Methods for Viewing Defects in Stretched Multi-Layer Films

As an alternative to removing a multi-layer film from a surface to which it has been applied for analysis using the Scanning Electron Microscopy Test Method herein, an applied film may be analyzed after its application to a surface using an optical microscope, or even a magnifying glass, to determine presence of defects including cracks within and splitting of the film. Many such defects are visible using these alternative methods.

### Example 1

A web-polymerized polyurethane carrier layer having a thickness of 5.7-mils was coated with 11 GSM of a polycarbonate polyurethane boundary layer that was then topcoated with 5 GSM polyurethane topcoat. The opposite side of the polyurethane carrier layer was coated with acrylic pressure sensitive adhesive to a thickness of 1.5 mils.

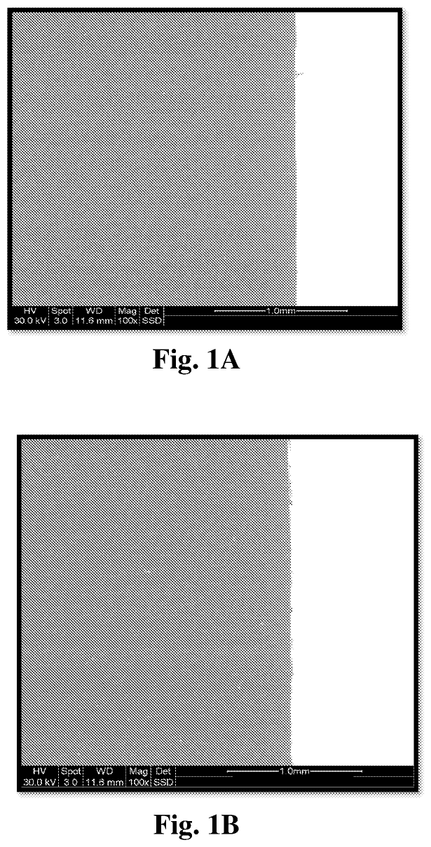

Samples were tested after exposure to the elevated temperature of about 90° C. for two hours. Results of SEM analysis of the film are tabulated in Table 1 and corresponding to the amount stretched. Photographs of the SEM images after the multi-layer film of Example 1 was stretched 30% and 60% are respectively included as FIGS. 1A and 1B herein.

### Comparative Example C1

A web-polymerized polyurethane carrier layer having a thickness of 6-mils was topcoated with 11 GSM polyurethane topcoat. The opposite side of the polyurethane carrier layer was coated with acrylic pressure sensitive adhesive to a thickness of 1.5 mils.

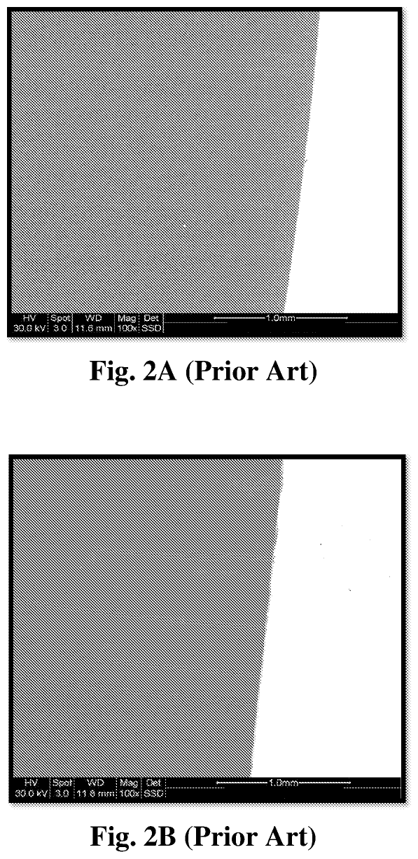

Samples were tested after exposure to the elevated temperature of about 90° C. for two hours. Results of SEM analysis of the film are tabulated in Table 1 and corresponding to the amount stretched. Photographs of the SEM images after the multi-layer film of Comparative Example C1 was stretched 30% and 60% are respectively included as FIGS. 2A and 2B herein. As illustrated in FIG. 2B, at least four substantially transverse cracks resulted after being stretched 60%.

### Comparative Example C2

An extruded polyurethane carrier layer (extruded from material obtained from Lubrizol under the Estane® ALR CL93A-V trade designation) having a thickness of 6-mils was topcoated with 11 GSM polyurethane topcoat. The opposite side of the polyurethane carrier layer was coated with acrylic pressure sensitive adhesive to a thickness of 1.5 mils.

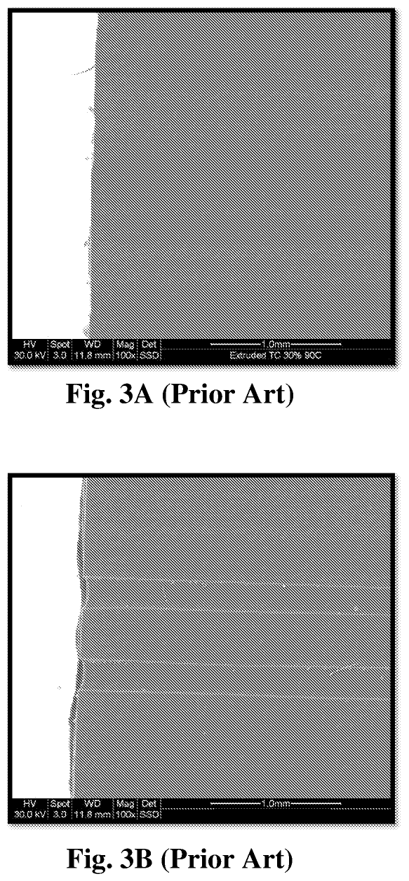

Samples were tested after exposure to the elevated temperature of about 90° C. for two hours. Results of SEM analysis of the film are tabulated in Table 1 and corresponding to the amount stretched. Photographs of the SEM images after the multi-layer film of Comparative Example C2 was stretched 30% and 60% are respectively included as FIGS. 3A and 3B herein. As illustrated in FIG. 3B, at least four large, substantially transverse cracks resulted after being stretched 60%.

TABLE 1

| Film | Amount Stretched | | | |
|---|---|---|---|---|
| Example | 30% | 40% | 50% | 60% |
| 1 | OK | OK | OK | OK |
| C1 | OK | OK | Cracking | Cracking |
| C2 | OK | Cracking | Cracking | Cracking |

As illustrated in Table 1, when stretched by 30%, none of the film examples exhibited compromised properties. Upon stretching further, however, the film sample of Comparative Example C2 cracked each time. The film sample of Example 1 remained uncompromised even when stretched by 60%. Upon stretching of 50% or 60%, the film sample of Comparative Example C1 cracked.

### Comparative Example C3

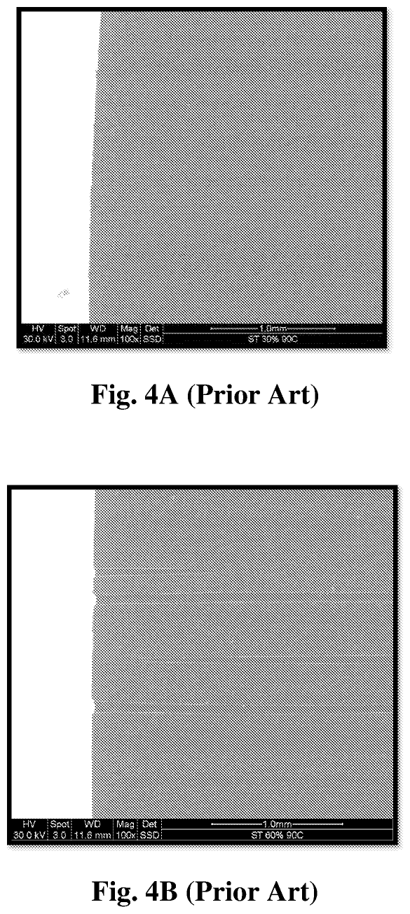

SunTek® PPF ULTRA paint protection film commercially available from Eastman Chemical Company (Martinsville, Va.) was analyzed. Samples were tested after exposure to the elevated temperature of about 90° C. for two hours. Photographs of the SEM images after the multi-layer film of Comparative Example C3 was stretched 30% and 60% are respectively included as FIGS. 4A and 4B herein. As illustrated in FIG. 4B, at least four large, substantially transverse cracks resulted after being stretched 60%.

### Example 2

A multi-layer film was prepared according to Example 1. Before testing, however, samples were exposed to the elevated temperature of about 90° C. for the extended period of twenty-four hours. Results of SEM analysis of the film are tabulated in Table 2 and corresponding to the amount stretched.

### Comparative Example C4

A multi-layer film was prepared according to Comparative Example C1. Before testing, however, samples were exposed to the elevated temperature of about 90° C. for the extended period of twenty-four hours. Results of SEM analysis of the film are tabulated in Table 2 and corresponding to the amount stretched.

### Comparative Example C5

A multi-layer film was prepared according to Comparative Example C2. Before testing, however, samples were exposed to the elevated temperature of about 90° C. for the extended period of twenty-four hours. Results of SEM analysis of the film are tabulated in Table 2 and corresponding to the amount stretched.

TABLE 2

| Film | Amount Stretched | | | |
|---|---|---|---|---|
| Example | 30% | 40% | 50% | 60% |
| 2 | OK | OK | OK | Cracking |
| C4 | OK | Cracking | Cracking | Cracking |
| C5 | Cracking | Cracking | Cracking | Cracking |

As illustrated in Table 1, when stretched by 30%, none of the film examples exhibited compromised properties. Upon stretching further, however, the film sample of Comparative Example C5 cracked each time. The film sample of Example 1 remained uncompromised even when stretched by 60%. Upon stretching of 50% or 60%, the film sample of Comparative Example C4 split.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited unless expressly stated otherwise. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

Further, as used throughout, ranges may be used as shorthand for describing each and every value that is within the range. Any value within the range can be selected as the terminus of the range. Similarly, any discrete value within the range can be selected as the minimum or maximum value recited in describing and claiming features of the invention.

In addition, as discussed herein it is again noted that the composition described herein may comprise all components in one or multiple parts. Further, while reference is made herein to preparation of the various intermediate components (e.g., prepolymers) recognize that some such intermediate components may be commercially available and, as such, can be used according to the invention as an alternative to otherwise preparing the same. Other variations are recognizable to those of ordinary skill in the art. Note also that any molecular weights given herein are number average molecular weights unless specified otherwise. Further, any properties described or measured herein are those existing at room temperature and atmospheric pressure unless specified otherwise.

1. A multi-layer film comprising sequential layers as follows:
a topcoat layer;
a boundary layer, wherein the boundary layer promotes stretchability of the multi-layer film;
a carrier layer; and
an adhesive layer.

2. The multi-layer film of claim 1, wherein the film is polyurethane-based.

3. The multi-layer film of claim 1, wherein the adhesive layer comprises a pressure-sensitive adhesive.

4. The multi-layer film of claim 1, further comprising a release film on an exterior surface of the adhesive layer.

5. The multi-layer film of claim 1, further comprising a carrier film on an exterior surface of the topcoat layer.

6. The multi-layer film of claim 1, wherein the carrier layer is in-situ polymerized.

7. The multi-layer film of claim 1, wherein after exposure to a temperature of about 90° C. for two hours and longitudinal stretching of the film by 40%, no visible cracks were observed or splitting of the film resulted, as evidenced by viewing of the film using the Scanning Electron Micrography Test Method herein.

8. The multi-layer film of claim 1, wherein after exposure to a temperature of about 90° C. for two hours and longitudinal stretching of the film by 60%, no visible cracks were observed or splitting of the film resulted, as evidenced by viewing of the film using the Scanning Electron Micrography Test Method herein.

9. The multi-layer film of claim 1, wherein after exposure to a temperature of about 90° C. for twenty-four hours and longitudinal stretching of the film by 40%, no visible cracks were observed or splitting of the film resulted, as evidenced by viewing of the film using the Scanning Electron Micrography Test Method herein.

10. The multi-layer film of claim 1, wherein after exposure to a temperature of about 90° C. for twenty-four hours and longitudinal stretching of the film by 60%, no visible cracks were observed or splitting of the film resulted, as evidenced by viewing of the film using the Scanning Electron Micrography Test Method herein.

11. A multi-layer film comprising sequential layers as follows:
a topcoat layer;
a boundary layer;
a carrier layer; and
an adhesive layer,
wherein M10 modulus of the boundary layer is at least about 20% greater than M10 modulus of the carrier layer.

12. The multi-layer film of claim 11, wherein M10 modulus of the boundary layer is at least about 20% greater than M10 modulus of the topcoat layer sandwiching the boundary layer.

13. The multi-layer film of claim 11, wherein M10 modulus of the boundary layer is at least about 50% greater than M10 modulus of the carrier layer.

14. The multi-layer film of claim 13, wherein M10 modulus of the boundary layer is at least about 50% greater than M10 modulus of the topcoat layer sandwiching the boundary layer.

15. The multi-layer film of claim 11, wherein M10 modulus of the boundary layer is at least about 75% greater than M10 modulus of the carrier layer.

16. The multi-layer film of claim 15, wherein M10 modulus of the boundary layer is at least about 75% greater than M10 modulus of the topcoat layer sandwiching the boundary layer.

17. The multi-layer film of claim 11, wherein M10 modulus of the boundary layer is at least about 100% greater than M10 modulus of the carrier layer.

18. The multi-layer film of claim 17, wherein M10 modulus of the boundary layer is at least about 100% greater than M10 modulus of the topcoat layer sandwiching the boundary layer.

19. A multi-layer film comprising sequential layers as follows:
a topcoat layer;
a boundary layer;
a carrier layer; and
an adhesive layer,
wherein the boundary layer has an ultimate elongation that is greater than ultimate elongation of the topcoat layer.

20. The multi-layer film of claim 19, wherein ultimate elongation of the boundary layer is at least about 25% greater than ultimate elongation of the topcoat layer.

21. The multi-layer film of claim 19, wherein ultimate elongation of the boundary layer is at least about 50% greater than ultimate elongation of the topcoat layer.

22. The multi-layer film of claim 19, wherein ultimate elongation of the boundary layer is at least about 100% greater than ultimate elongation of the topcoat layer.

23. A multi-layer film comprising sequential layers as follows:
a topcoat layer;
a boundary layer;
a carrier layer; and
an adhesive layer,
wherein M10 modulus of the carrier layer is less than about 20 MPa at 25° C.

24. The multi-layer film of claim 23, wherein M10 modulus of the carrier layer is less than about 15 MPa at 25° C.

25. The multi-layer film of claim 23, wherein M100 modulus of the carrier layer is less than about 5 MPa at 25° C.

26. The multi-layer film of claim 23, wherein M100 modulus of the carrier layer is less than about 4 MPa at 25° C.

27. A multi-layer film comprising sequential layers as follows:
a topcoat layer;
a boundary layer;
a carrier layer; and
an adhesive layer,
wherein M100 modulus of the boundary layer at 60° C. is at least about 60% of M100 modulus of that boundary layer at 25° C.

28. The multi-layer film of claim 27, wherein M100 modulus of the boundary layer at 60° C. is at least about 70% of M100 modulus of that boundary layer at 25° C.

29. The multi-layer film of claim 1, wherein the boundary layer has a thickness that is less than about 50% of thickness of the carrier layer.

30. The multi-layer film of claim 1, wherein the boundary layer has a thickness that is less than about 20% of thickness of the carrier layer.

31. An article comprising at least one surface having on at least a portion thereof the multi-layer film of claim 1.

32. The article of claim 31, wherein the article comprises a motorized vehicle.

33. The article of claim 31, wherein no visible cracks were observed or splitting of the multi-layer film occurred, as evident upon viewing of the film of the article using the Scanning Electron Micrography Test Method herein.

34. A method of using the multi-layer film of claim 1 to cover a surface on a motorized vehicle, the method comprising:
providing the multi-layer film of claim 1; and
applying the multi-layer film to the surface of the motorized vehicle.

35. The method of claim 34, wherein the surface is at least partially painted.

36. The method of claim 34, wherein the multi-layer film comprises paint in film form.

37. The method of claim 34, wherein the multi-layer film is heated and stretched to conform to the surface.

38. The method of claim 34, wherein the surface is non-planar.

39. The method of claim 34, wherein no visible cracks were observed or splitting of the multi-layer film occurred as a result of the application, as evident upon viewing of the film after application of the film to the surface of the motorized vehicle.

40. A method of forming the multi-layer film of claim 1, the method comprising a step of in-situ polymerizing the carrier layer.
